(19) United States
(12) Patent Application Publication
(10) Pub. No.: US 2002/0194069 A1
(43) Pub. Date: Dec. 19, 2002

(54) Business systems and methods for consumer/vendors interface via the internet to automatically provide discounts

(76) Inventors: Sunil V. Thakur, Humble, TX (US); Zulfiqar N. Momin, Sugarland, TX (US)

Correspondence Address: Guy McClung, Suite 347, 16690 Champion Forest Drive, Spring, TX, 77379-7023, US

(21) Appl. No.: 10/085,196

(22) Filed: Feb. 27, 2002

Related U.S. Application Data
(63) Continuation-in-part of application No. 09/154,906, filed on Sep. 17, 1998, now Pat. No. 6,101,774.
(62) Division of application No. PCT/US00/22503, filed on Aug. 16, 2000.

(51) Int. Cl. G06F 17/60

(52) U.S. Cl. 705/14

(57) ABSTRACT

A business system including, in at least certain embodiments, a magnetic strip card with consumer identifying information encoded thereon, the information identifying a consumer, the consumer desiring to conduct a transaction with a vendor at a vendor location, a host system remote from the vendor location that maintains information about discounts from the vendor, an apparatus at the vendor location for reading the consumer identifying information on the magnetic strip card, the apparatus interconnectible with and able to communicate with the host system for ascertaining any discount of the discounts applicable to the transaction, and apparatus and/or system(s) apart from the magnetic strip card for automatically applying any applicable discount of the discounts related to the transaction at the vendor location for the benefit of the consumer, without consumer selection of any of the applicable discounts and without requiring consumer awareness of any of the applicable discounts.

### RELATED APPLICATIONS

This is a continuation-in-part of U.S. application Ser. No. 09/154,906 filed Aug. 17, 1999; and a division of PCT Application PCT/US00/22503 filed Aug. 16, 2000 and of U.S. application Ser. No. ______ filed ______ based on the said PCT Application.

### BACKGROUND OF THE INVENTION

1. Field of The Invention

This invention relates to business systems with which a customer can be in direct electronic communication with a vendor, e.g., via the Internet. In certain aspects, this invention relates to such systems that also provide discounts to consumers and provide the dissemination of sales information. In one aspect, discounts are applied automatically and/or contributions are made automatically to a retirement account of a consumer using the system.

2. Description of Related Art

For years the prior art has included many ways to provide coupons to consumers. Coupons are provided by direct mailing, in newspapers and magazines, and at points of sale. Coupons are provided on the reverse of cash register receipts; with invoices for goods; and as prizes in various contests.

More recently various prior art systems employ a computerized accessible database system, network, or computerized global communications system such as the Internet to provide coupons to consumers. For example, SuperMarkets Online, Inc. has an Internet ValuPage™ online coupon system that enables a consumer to produce a bar-coded coupon page at home on a personal computer which can then be taken to a store and scanned for the consumer to enjoy the discount related to the coupon(s). In one aspect the system produces Web Bucks coupons for the consumer at a checkout. In the ValuPage system certain types of goods, e.g. baby or pet items, can be deleted from a ValuPage™ coded sheet. The ValuPage™ system uses a consumer's zipcode to determine stores in the consumer's area capable of issuing and honoring ValuPage™ coupons.

U.S. Pat. No. 5,806,044 discloses a system for dispensing and redeeming electronic discount coupons which includes a personal computer with hardware and software for receiving an electronic coupon from the system of computer networks, translating the received coupon into a binary format, and sending the binary-formatted coupon to a card-writing device. The card-writing device writes the coupon data onto a portable customer card (“smart card”) approximately the size of a credit card. Then, the customer goes to the store with the card and, upon completion of shopping, redeems the electronic coupons at the checkout area, by inserting the card into a checkout station. During checkout, the customer is credited with the value of a coupon when UPC data from a bar code reader corresponds to a coupon stored on the card.

U.S. Pat. No. 5,832,457 discloses a system for automatically distributing discount coupons or certificates in a retail store, conditioned on a preselected combination of present and past shopping behavior of a customer whose order is being processed at a checkout stand. Generation of a printable discount coupon can be based on any desired combination of customer-supplied data, obtained from a customer identification data base, past shopping activity, derived from data gathered during previous customer visits to the store, and present shopping activity, as evidenced by items identified in he current customer order. Collection of data pertaining to past behavior of customers is facilitated by filtering all sales transaction data at the point of sale. If all of the preselected conditions for generation of a coupon are satisfied, the coupon is generated and printed at the checkout stand.

U.S. Pat. No. 5,857,175 discloses a system for presenting customized special offers to customers, the special offers including targeted offers to a customer selected from a plurality of customers, and for collecting purchasing behavior information concerning the customers, the system having a computer including a database containing customer account information providing information specific to a particular customer account; the computer also including a database containing special offers including a targeted offer which is to be made to selected customer accounts on the basis of targeted offer targeting parameters; a plurality of customer cards, each customer card having machine readable card information indicating at least identification of the card with a particular customer account; a customer interface in communication with the computer to transfer data therebetween; the customer interface having a card reader for reading machine readable card information from the customer card; the computer including means for generating a customized customer offer list available to that particular customer account which includes the special offer; an offer communicator for communicating the customer offer list to the customer for which it is generated; a check-out at which the customer presents purchased item information indicating items being purchased by the customer; the check-out including a card reader for reading the customer card; the computer including means for sending information from the customized customer offer list to the check-out; the computer further including means for collecting customer purchase information which is indicative of items being purchased by the customer via the check-out; the computer still further including means for editing the customer account information to reflect items purchased by the customer.

U.S. Pat. No. 5,740,549 discloses an information and advertising distribution system with a data server that stores and updates a database of information items and advertisements. The information items and advertisements are each categorized so that each has an associated information category. Workstations remotely located from the data server each include a display device, a communication interface for receiving at least a subset of the information items and advertisements in the data server's database and local memory for storing the information items and advertisements received from the data server. An information administrator in each workstation establishes communication with the data server from time to time so as to update the information items and advertisements stored in local memory with at least a subset of the information items and advertisements stored by the data server. An information display controller in each workstation displays on the workstation's display device at least a subset of the information items and advertisements stored in local memory when the workstation meets predefined idleness criteria. At least a subset of the workstations include a profiler for storing subscriber profile data. The subscriber profile data represents subscriber information viewing preferences, indicating information categories for which the subscriber does and does not want to view information items. The information display controller includes a filter for excluding from the information items displayed on the display device those information items inconsistent with the subscriber profile data.

U.S. Pat. No. 5,341,505 discloses a distributed computer system that enables end-users without direct access to a ZIP+4 database to obtain ZIP+4 zipcode values for specified addresses from a remotely located computer having a ZIP+4 database. The remotely located computer includes a modem for receiving calls from end-user's computers and a ZIP+4 database with query response software for transmitting ZIP+4 zipcode values retrieved from its ZIP+4 database in response to address information received from end-user computers. End-user computers that utilize the remotely located ZIP+4 database each include a modem for communicating with the remotely located ZIP+4 database computer, an address input program for storing address information input by a user, and a remote zipcode retrieval program for transmitting via the modem the stored address information to the remotely located ZIP+4 database computer and for receiving ZIP+$ zipcode values from the remotely located computer. The end-user computers preferably include a printer, and an envelope printing program for directing the printer to print ZIP+4 barcodes on envelopes, as well as other post-office mandated artwork. The address input program on the end-user's computer preferably is linked to the remote zipcode retrieval program such that a single predefined keystroke by the user causes the end-user's computer to call the remotely located computer, send a specified set of address information, receive ZIP+4 zipcode values, and insert the received ZIP+4 zipcode values into the stored address information.

U.S. Pat. No. 5,128,752 discloses a system in which tokens and coupons are generated in a television viewer's home by the viewer entering selected product information and authentication data transmitted to and displayed on the television into a home generating unit. The tokens and coupons can be presented to stores or redemption facilities for prizes and discounts on selected products. The matrix used to record the product information and verification data may also be provided with a code for use in giving additional prizes to purchasers whose code matches a predetermined code. The generating unit may also comprise a memory for storing information regarding the coupons generated by the unit for later review by marketing and manufacturing companies.

A publication of Apr. 13, 1999 in the Official Gazette, Patents (under the heading “U.S. Pat. No. 5,894,520” listing the name of Jakob Nielsen and SunMicro Systems, Inc.) discloses a method executed in a computer system for regulating discounts on merchandise distributed through networked computer systems, the method including the steps of: when a user purchases merchandise, creating a discount coupon valid toward the repurchase of the merchandise, the discount coupon including information regarding the user and the purchase of the merchandise; encrypting the discount coupon; and sending the encrypted discount coupon to the user.

There has long been a need, recognized by the present inventors, for a system that provides to a consumer direct electronic communication with a vendor and, in one aspect, coupons and/or sales information limited to a relatively small defined geographic area of interest to a consumer; for example, an area within one, two, or five miles of a consumer's home, place of work, or location while travelling.

### SUMMARY OF THE PRESENT INVENTION

The present invention, in certain aspects, provides a system for direct electronic communication between a consumer and a vendor, e.g., using a communications system or network such as, but not limited to, the Internet. In certain aspects of the system, the system records one or more consumer/vendor transactions, calculates a future discount for that consumer for use with that vendor; alerts the consumer to the future discount; and applies the discount when the consumer makes a subsequent purchase from that vendor—either online or at a location of the vendor. In another aspect, the system calculates an amount, based on the amount of a consumer's purchase or purchases, to be contributed to a retirement account for the consumer—either periodically (e.g. each month), with each purchase; with a specific number of purchases, e.g., every five purchases; or when a set dollar amount level of purchases is reached.

The present invention discloses and teaches, in certain embodiments, a method for disseminating vendor information, and/or for generating a coupon and/or retrievable information about a coupon, which method includes contacting a host system by a consumer, optionally identifying a pertinent geographic area of interest to the consumer, identifying at least one vendor doing business in the pertinent geographic area, retrieving from the host system information related to the at least one vendor and at least one coupon currently provided by the at least one vendor, and generating said at least one coupon for the consumer. In one aspect such a method includes automatically downloading to the consumer's computer or other personal communicator an index of coupons available for the pre-determined pertinent geographic area and/or coupons themselves. In another aspect, alternatively (or in addition to the actual printing of a coupon) retrievable information about the coupon: is coded on a magnetic strip, e.g. on a card, which information may be retrieved for redemption at a remote location or point of sale; is stored in appropriate means in the Host System and is selectively retrievable therefrom on demand; and/or is stored in appropriate apparatus at the vendor location(s) where it is retrievable for a consumer/vendor transaction. In one aspect the host system complies and stores data for all transactions of all consumers using the system, e.g. on a monthly, weekly, or daily basis and prepares statements (or a third party administrator prepares statements) for each consumer.

In other aspects the present invention discloses and teaches a method for generating, retrieving, and displaying vendor information—either selectively on demand or automatically—which includes contacting a host system by a consumer, optionally identifying a pertinent geographic area of interest to the consumer, identifying at least one vendor doing business in the pertinent geographic area, retrieving from the host system information related to the at least one vendor, and displaying said information for the consumer.

The present invention, in certain embodiments, discloses and teaches a system in which a consumer at a location such as home or work accesses a host system [e.g. but not limited to a centralized computer system with its own database; a network of computers; a computer system which accesses other pertinent databases; or the Internet global communications system (henceforth herein “Internet” or “IGCS”)]. In accessing the host system either: 1. The consumer inputs location data for generating coupons and/or sales information pertinent to a specific geographic location; or 2. The system itself recognizes the consumer's location based on: the phone number used to communicate with the host system; and/or on previously inputted and/or identified data or identifier(s).

In certain embodiments the consumer inputs one, some or all of the following so that the host system can identify the pertinent geographic area (henceforth “PGA”): phone number area code; phone number area code and first three digits of the phone number; phone number area code and first six digits of the phone number; phone number area code and entire phone number; five digit zipcode; nine digit zipcode; global positioning system location coordinates; and/or actual physical address.

In certain embodiments the host system itself uses one, some, (in any possible combination) or all of the information listed above to determine a PGA for the consumer. Once the PGA is determined, the host system scans its database(s) for information related to vendors within that PGA. Then the host system provides the information to the consumer's computer. The “information” may include coupons shown on the consumer's computer monitor and printable at the consumer's computer printer and/or sales information regarding the vendors' goods, services, specials, programs, etc. The term “vendor” can include, but is not limited to, seller, manufacturer, sponsor, utility companies, advertiser, businesses, broadcaster and supplier.

The information that can be supplied in systems according to the present invention, as mentioned above and as described in detail below, may include typical “yellow pages” type information; advertising information; future promotions; on-going current sales information; current inventory and availability information; discounts; volume discounts; coupons; classified information; and for sale information (autos, houses, etc). Additionally, the information may include how to directly contact a vendor or a particular person at a vendor.

In certain particular aspects of a system according to the present invention, a consumer can pinpoint a particular type of information/coupons, etc. desired and exclude others. For example, a consumer interested in a restaurant and nearby theaters could exclude all other types of information. Also, in certain aspects, each consumer is asked about desired coupons not presently available. This information is then used by the host system owner to seek additional coupon providers.

In certain particular embodiments the host system will make it possible for a consumer to specify the extent of a particular PGA and then to increase or decrease the size, either to change the actual physical area of the PGA and/or to include additional mail zipcodes and/or phone area code areas. For example a consumer may want to know about bike repair shops within half a mile of her home. Finding that there are none (using a system according to the present invention) she may then query the system for such shops within five miles of her home. Alternatively, if a five-mile extent query reveals many such shops, she can reduce the extent to one mile to reduce the number of prospects; or if a five zipcode query reveals a large number of prospects, she can reduce the query to include only 1, 2, 3 or 4 of the zipcodes.

In another embodiment of a system according to the present invention, an index listing of businesses (e.g. Joe's Bar & Grill, John's Store); and/or business types (e.g. restaurants; department stores) is provided from which the consumer can select one or more entries which are then correlated with the PGA. In another embodiment, a consumer on-screen identifies the type of goods or services of interest.

In one particular embodiment of the present invention, once the host system has received information about a particular consumer including, but not limited to, coupon preferences, the host system can provide daily (or some other time periodic) information customized for the particular consumer. Such information may be provided by phone, fax, and/or email.

In certain embodiments of systems according to the present invention, a vendor pays to have its information made available through the system.

Coupons and/or discounts generated by a system according to the present invention can be redeemed in a variety of ways, including, but not limited to, at retail stores; via the IGCS; via a vendor's web site; by phone; by fax; and/or by mail. The system can initiate delivery by any suitable known method, including, but not limited to, messenger service (e.g. Federal Express); U.S. mail; a vendor's own delivery system; etc.

In certain aspects of systems according to the present invention a map is provided to a consumer who has chosen a particular vendor showing the consumer how to travel to the vendor's location.

For consumers who are traveling, the system can provide information related to an ultimate destination, information related to an interim destination (e.g. 30 miles or 40 minutes down the road), or information related to a present location. Vendors for any such location can achieve valuable advertising via a system according to the present invention which may mean the difference between a sale and no-sale, particularly for business locations not visible from a particular roadway.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide:

New, useful, unique, efficient, nonobvious systems and methods for providing direct electronic consumer/vendor contact for business transactions via a system such as the Internet global communications system;

New, useful, unique, efficient, nonobvious systems and methods for providing coupons, discounts, and/or vendor information to a consumer;

Such business methods and/or coupon methods which include defining a particular geographic area of interest to a consumer;

Such methods which can make coupons and discounts, available to consumers even if they are unaware of them;

Such method which provide the options of increasing or decreasing the size of a particular geographic area of interest;

Such methods and systems which automatically download information and/or coupons to a system user;

Such method and system which determine, store, and apply a future discount based on a system user's present transaction;

Such methods and systems for determining and making contributions to a system user's retirement account based on the value of a transaction—either instantaneously at the time of purchase or periodically based number of purchases and/or on a pre-set total dollar amount level of purchases; and

Such method which can be used for alternate locations, including locations when traveling.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIGS. 1 and 1A are schematic views of a system according to the present invention.

FIG. 2 is a schematic view of a personal computer useful with a system according to the present invention.

FIG. 3 is a schematic view of a particular computer screen in a system according to the present invention.

FIGS. 4 and 5 show schematically an embodiment of the present invention.

FIG. 6 is a block diagram of a communication system according to the preferred embodiment of the present invention.

FIG. 7 is an electrical block diagram of an Internet node according to the preferred embodiment of the present invention.

FIG. 8 is a timing diagram illustrating an exemplary message coupon format according to the preferred embodiment of the present invention.

FIG. 9 is a flow diagram illustrating an operational sequence for the communication system in FIG. 1 according to the preferred embodiment of the present invention.

FIG. 10 is a flow diagram illustrating an operational sequence for recording coupon transactions in the coupon database.

FIG. 11 is a flow diagram illustrating an operational sequence of the user registration process, according to the preferred embodiment of the present invention.

FIG. 12 is a flow diagram illustration an operational sequence of the coupon indicia generating process, according to the preferred embodiment of the present invention.

FIG. 13 is a flow diagram illustration an operational sequence for the Internet Coupon Notification Center, according to the preferred embodiment of the present invention.

FIG. 14 is a block diagram illustration an electronic coupon verification and redemption system according to the preferred embodiment of the present invention.

FIGS. 15-19 are block diagrams showing various methods according to the present invention.

### DESCRIPTION OF EMBODIMENTS PREFERRED AT THE TIME OF FILING FOR THIS PATENT

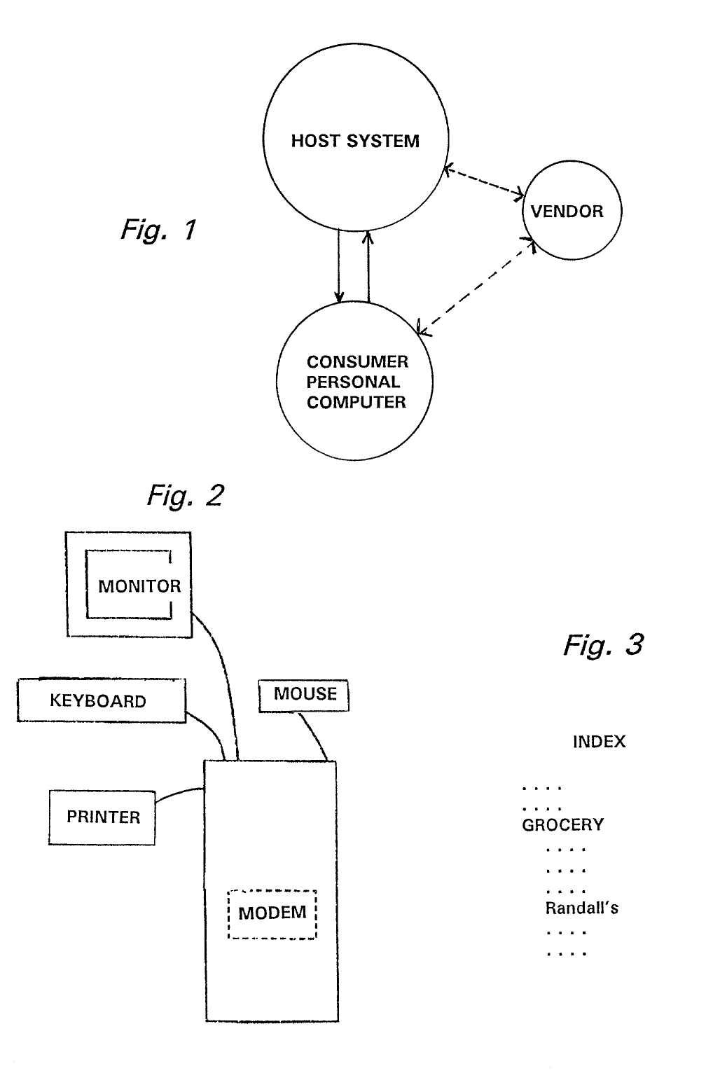

Referring now to FIGS. 1 and 2, in one method according to the present invention a consumer uses a Consumer Personal Computer to access a Host System. The Host System includes a computer-accessible database with vendor information that includes available coupon(s) and other information as discussed above. The Host System can be accessible in any known way including, but not limited to, by phone, by cable, and by wireless systems. It is within the scope of this invention for the Host System to be an accessible stand-alone computer system; an Internet service provider (“ISP”) that provides access to the Internet; or any known computerized network that includes vendor information. The Host System (and any system disclosed herein) has well known means for accomplishing each of its functions, including, but not limited to, means for storing digitized information; means for mathematical calculation; means for determining the extent of a particular geographic area; means for transmitting and/or receiving data and/or digitized information; means for downloading “Pay Per View” events or other DATA/VIDEO/AUDIO programming using the host system as intermediary or data base—in one aspect applying future rewards as described below; means for contacting a host system by two or more parties from two or more independent locations simultaneously or by email at the same time for the purpose of communicating with each other as in current chat rooms on the Internet; means for establishing contact with a host system by two or more people from the same telephone number to engage in different interactions with the host system, e.g. one person reviewing coupons and another verifying retirement account status; and means for a host system to automatically receive a signal from a disabled car identifying its PGA and/or location and automatically connecting a consumer to a vendor offering emergency and/or wrecker/repair services and, in one aspect, also directing an emergency communication to one or more preprogrammed telephone numbers, e.g. family, police, insurance company, etc.

Following accessing of the Host System with the Consumer Personal Computer, the consumer inputs, e.g. via the keyboard of the computer as in FIG. 2, data indicative of a pertinent geographic area (“PGA”) of concern to the consumer. A computer in the Host System translates this input data into a particular PGA. The computer displays for the consumer on the monitor of the consumer's computer an Index listing (e.g. see FIG. 3) of the goods and services in an accessible database of the Host System (or of a database accessible by, yet outside of, the Host System). The consumer chooses a vendor from the Index listing, e.g. Randall's grocery store, e.g. by clicking the computer's mouse on “Randall's” on the computer monitor's screen; by typing in “Randall's” on a block or window provided on screen; or by using keyboard keys to move a highlighting block over “Randall's” and then pushing “Enter” on the keyboard.

A computer of the Host System then determines whether there is a Randall's grocery store in the PGA. If there is, the computer then correlates this Randall's location with coupons listed in the database for Randall's. The available coupon or coupons are then shown on the screen of the computer monitor. Either the consumer can select which coupons to print out on the computer's printer or the system can automatically print all available coupons. Alternatively, the Host System can query the consumer regarding which, if any, coupons are to be printed out and, as the name “Randall's” was indicated, the consumer can indicate which coupons are to be printed. Alternatively, the computer can apply the PGA to the database prior to providing the Index listing so that anything appearing in the Index is within the selected PGA.

In another embodiment, the Host System automatically determines a PGA for the consumer based on particular identification criteria, e.g. but not limited to geographic indicators such as phone numbers (e.g. of the particular modem of the computer), zipcodes, or both and a default PGA extent, e.g. within a two mile radius of the consumer's location as indicated by the phone number, zipcode, and/or GPS coordinates, etc.

It is within the scope of this invention for the Host System to store information regarding applicable coupons and/or discounts for access via the Host System at a location of the vendor for use by the consumer or for use online by the consumer—without the need to actually print out a paper coupon. In one particular embodiment a cash register or other appropriate apparatus at a vendor location in communication with the Host System—in communication with the Host System periodically to retrieve information to be used upon later arrival of the consumer at the location, to be used on line by the consumer, or upon arrival of the consumer at the vendor location—automatically applies previously-determined discounts and/or coupon amounts to an item or items selected by the consumer. It is also within the scope of this invention for the user to print out actual paper coupons with the user's own printer. It is also within the scope of this invention to employ a card processor in conjunction with the computer of FIG. 2 to encode a card with a magnetic strip, like a typical credit card, with the discounts, coupon or coupons generated by the consumer's inquiry. Alternatively, the printer can simply print out one or more Universal Product Code bar codes that can be scanned at a vendor's location to provide the discount associated with a vendor coupon.

As shown by dotted lines in FIG. 1, a vendor may be put in touch directly with a consumer following a consumer inquiry to the Host System. In one aspect this is done with hyperlinks. For other reasons as discussed below a vendor will also be in direct contact with the Host System. Such direct contact may then be used for any consumer/vendor interaction and/or transaction, in addition to the provision of a coupon to the consumer.

In one particular embodiment, the consumer makes an initial inquiry to the Host System and on the phone or on-line fills out a Host System questionnaire that includes specific location data for the consumer. In another aspect, the consumer may provide data for a plurality of alternative locations which, in the future, may be indicated for an alternative PGA of interest. The Host System stores particular PGA information for the particular consumer so that in the future the consumer's initiation of an inquiry automatically invokes a specified pre-determined PGA.

In another embodiment the consumer is provided a magnetic strip item, e.g. but not limited to a plastic card (which, in one aspect, may be any credit card, discount card, debit card, prepaid card) usable at any vendor included in the Host System's database that, at a vendor location, is scanned to provide the consumer with the benefit of any applicable current coupon, discount, or special—whether the consumer was aware of such or not. Also, the consumer can use the card at an information system at the vendor's location to view and/or hear information about then-current discounts, etc. In another aspect, a consumer using a vendor's phone number, e.g. a 1-800 number, or Internet telephone can hear vendor information. In one aspect, the Host System computes and stores a future discount for the card user (or for an on-line user or user of printed-out coupons) and/or an investment amount for a user retirement account. In the future when the user again makes a purchase, by any method described herein, the Host System automatically applies the previously calculated future discount. Payments (which can be made by: the host system, a third party administrator, a vendor, and/or by the purchaser) can be made automatically once a purchase (or purchases) is completed. The magnetic strip card may be any currently used credit card, debit card, discount card, or prepaid car with appropriate encoding.

The Host System can keep a record of the consumer's transactions with each vendor in its database which may be made available by phone and/or via the system of FIG. 1 on demand to the consumer and/or to the vendor(s). Data for all consumers and vendors can be made available to consumers and/or vendors (or other interested parties).

Payment, refund, and accounting transactions to be accomplished via the Host System and for the method of FIGS. 1-3 to be effected concluding with delivery of goods to the consumer, without the need for the consumer to actually go to the vendor's physical location. This can be done entirely with the Host System as middleperson or with the consumer having some direct contact with the vendor.

Either upon initiation by the consumer or automatically, enlarged or reduced PGA's can be invoked. For example, upon finding no vendor of interest in a two-mile-radius PGA, a computer of the Host System can automatically expand the PGA by a pre-set increment, e.g. by another mile, and proceed to satisfy a consumer inquiry. Similarly, when a particular consumer inquiry in view of a particular PGA produces a listing of too many vendors (e.g. a pre-set number of twenty), a computer of the Host System can automatically (or upon consumer input) reduce the PGA size to produce a more desirable number of vendors.

In another embodiment of systems and methods as described above, a potential vendor accesses the Host System, e.g. by mail, by phone or with a computer like that of FIG. 2. A vendor questionnaire seeking information regarding vendor location(s), products, services, sales, coupons, terms, phone numbers, credit worthiness, personal contacts, etc. is filled out by the vendor. An account is set up for the vendor and an access code is provided for the vendor to update, supplement and change the information to be provided about the vendor by the Host System. The Host System can also provide by phone, by mail or on-line via the Host Systems computer(s) and/or network(s) information about how to employ the system, how to input information to it, how to get in direct contact with a consumer, and how to provide for discounting and for coupon use. The Host System can also provide information to the vendor regarding consumers who have already used the system. The Host System can provide the vendor with a unique account identification number.

In one particular aspect of the present invention, the Host System itself may provide bill sending and bill paying services for a user or the Host System can connect the user to a particular company and/or bank (or other financial institution) so that the user, via the system, can pay bills. In one aspect the Host System simply sends bills to a user who has already established an account with the Host System and informed the Host System of the identity of companies (utilities, mortgage companies, oil and gas companies, hospitals, clinics, telephone companies, etc.) and account numbers with those companies. The Host System establishes the appropriate connections with each company. Similarly, billing for vendors can be accomplished. In another aspect, the Host System downloads to a utility company information about all consumers in a particular area, e.g. determined by phone number and/or zipcode. In another aspect a utility (or any other vendor) mails no invoices to its customers and all billing and payment is done via the Host System. A menu provided by the Host System will have a “BILLING” choice.

In certain embodiments, it is within the scope of this invention to provide the display, payment and adjustment or refund of recurring monthly (quarterly or yearly) bills of utility companies and the like (e.g. gas, electric, water, telephone, cable ISPs, mortgage company, bank, insurance company, day-care, etc.). The billing details of all individual consumers of a specific vendor (or a service provider) that are signed up with a Host System are provided as a database by the service provider to be fed directly into the information network of the Host System from where it is disseminated according to the zipcodes and automatically downloaded at each individual consumer's PC/TV screen which would, in one aspect, flash “You have a bill waiting to be paid!” The consumer might then directly charge his account with the Host System to pay on-line/off-line, thereby earning a contribution towards a Retirement Account. The service providing company saves the costs involved in invoicing, billing, and mailing.

For travel purposes, a user can input a different location, e.g. a travel destination or way station, and receive information for a PGA based on the travel location rather than an original home or office location. A traveler (e.g. in a car, mobile home, bus, train, boat or plane) with a laptop computer (or other appropriate device) and a global positioning system monitor can provide a GPS location to the Host System and receive information as in the system described for FIGS. 1-3 for a PGA based on the GPS location.

In one particular aspect of the present invention, a traveler (e.g. in a car, mobile home, bus, train etc). with a laptop computer (or any other comparable on-board system) and a global positioning system monitor provides his GPS location to a Host System and receives an automatic downloading of all relevant information about a selected vendor's services, e.g. motels/hotels and restaurants within a specified range (e.g. five or ten miles). This enables the traveler to choose a motel, hotel or restaurant often without actually first seeing a vendor's physical location.

In certain aspects of methods according to the present invention a consumer presents a magnetic strip card to a clerk at a vendor's counter to swipe through a validating device or cash register. This establishes a connection between the vendor (e.g. via a merchant) and the consumer's account number thereby confirming membership or participation in the proprietary system. Then relevant information downloads automatically from a database of a central computer of the Host System regarding the specific vendor's coupons/offers/rebates etc. thereby enabling the check-out of the currently advertised and rebated items out of a total of actually purchased items for the purpose of redemption and discount.

According to the system and method of the present invention, and with reference to FIG. 1A, a consumer engages in a purchasing activity at a signed-up retail merchant's location. As is discussed elsewhere in this invention, a proprietary web-site 13 is maintained on which merchants 15 can advertise and consumers 17 can obtain information and coupons. The present invention also includes a Host System database 11 with information on the consumer 17, the merchant 15, and the coupons available to the consumer 17. When making the purchase, the consumer 17 is asked to swipe a credit card approved by the Host System at point-of-sale terminal 21 before the items to be purchased are scanned by the cashier. Assuming that the appropriate software is loaded at point-of-sale terminal 21, the magnetic strip on the special credit card will first trigger an initial split dial-up step 19 and route the query to the proprietary Host System database 11 (while holding back the initiation of the financial authorization of the credit card temporarily) to effect a real-time, itemized download of the rebates/discounts advertised on the proprietary web-site 13 by that specific merchant 15. This should enable the cashier to cross-check those few discounted items against the total number of items to be scanned at the time, so that the applicable discounts are properly credited and shown as such on the receipt of the consumer 17.

After the rebates/discounts are realized for the consumer 17, the total dollar amount to be charged to the credit card of the consumer 17 will be forwarded through a delayed dial-up step 23 to the payment processors 25 for authorization and eventual settlement purpose over the Payment Network or System Network 27 (including credit card companies like Visa/Discover/AMEX/MasterCard etc.) to issuing member banks 29. An identical procedure should apply (possibly with some necessary modifications) for purchases made in the virtual world charging credit cards on-line via an Internet appliance (PC or Cell Pones etc.).

The present invention, therefore, provides in certain, but not necessarily all embodiments, a method for generating a coupon which includes contacting a host system by a consumer, identifying a pertinent geographic area of interest to the consumer, identifying at least one vendor doing business in the pertinent geographic area, retrieving from the host system information related to the at least one vendor and at least one coupon currently provided by the at least one vendor, and generating said at least one coupon for the consumer.

In other aspects the present invention discloses and teaches methods for generating vendor information which includes contacting a host system by a consumer, identifying a pertinent geographic area of interest to the consumer, identifying at least one vendor doing business in the pertinent geographic area, retrieving from the host system information related to the at least one vendor, and displaying said information for the consumer.

A vendor desiring to advertise on the Host System and have its coupons, etc. provided to consumers via the Host System sets up an account with the Host System—either on-line, by phone, in person, by email or by mail. The account can be set up so that the vendor's periodic payments to the Host System are automatically paid from a prepaid account, a bank account, and/or charged to a credit card account. In one aspect, a percentage of each transaction via the system is paid to the owner of the system. Each vendor, in one aspect, is assigned a specific account number and password for accessing the Host System to provide information, change an ad, etc. At any point at which the vendor fails to make required payments, the Host System can prevent that vendor's information, coupons, etc. from appearing to users of the system.

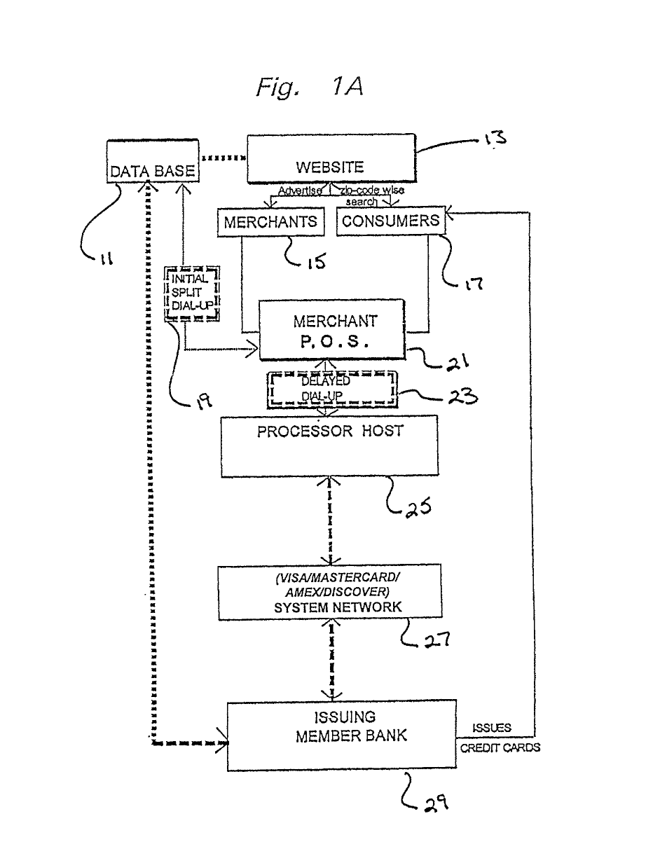

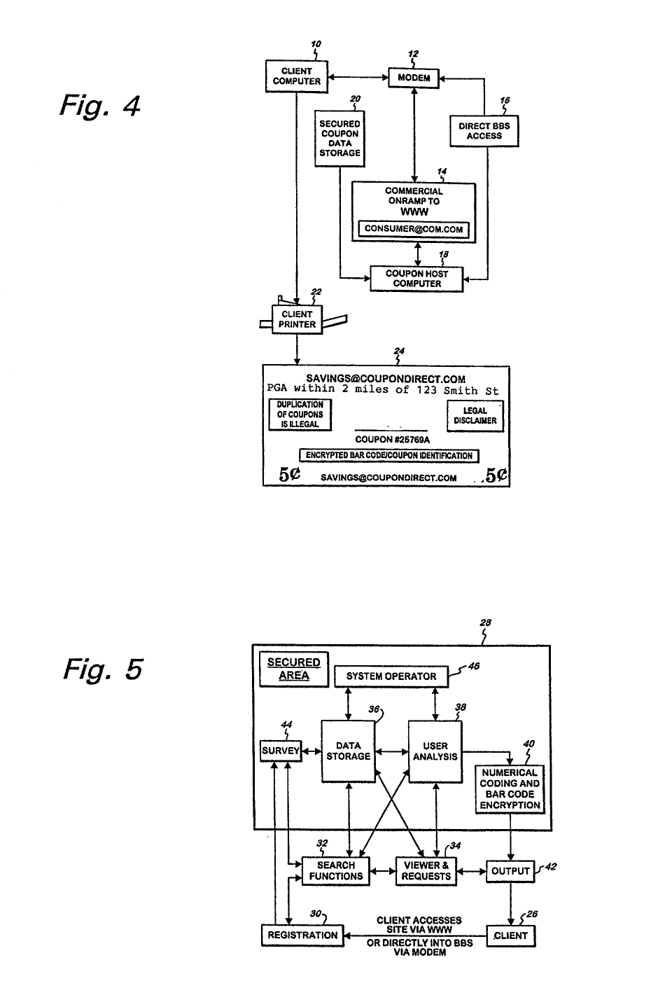

### FIGS. 4 and 5

FIGS. 4 and 5 refer to an embodiment of the present invention which is an improvement of the subject matter of U.S. Pat. No. 5,907,803 (which patent is incorporated fully herein for all purposes). As shown in FIG. 4, a computer, e.g. a personal computer, or a client computer 10 is connected to a host computer 18 containing coupon information. In one aspect the coupon information is in a searchable database indexed by product or service and by supplier. The client computer 10 is in one aspect connected by modem 12 to a commercial service 14 for accessing a network, such as the Internet, or by direct access 16 from a bulletin board system. The host computer 18 (which can also be the host computer for any Host System or central computer for any embodiment disclosed herein) contains a coupon data storage area 20, preferably secured. The personal or client computer 10 is, optionally, connected to a printer 22 for printing a coupon 24. A coupon 24 printed by the printer has encoded thereon indicia for identifying the coupon. This may be accomplished with an encrypted bar code. The coupon identification may incorporate the client computer's 10 address and the date to prevent unauthorized duplication. In the coupon distribution system illustrated in FIG. 4, a potential consumer using the personal computer or client computer 10 connects to a host computer 18, e.g. to view available coupons. The host computer 18 receives and recognizes the potential customer's phone number, matches the phone number with an appropriate zipcode using a computer database that correlates the phone numbers and the zipcodes and, without request or prompting, correlates the phone number with a pertinent geographic area. Either automatically or, if requested, the host computer downloads to the potential customer a listing of coupons available in the PGA. The potential customer may go through screen after screen of available coupons or may search the listing by inputting particular types of goods and/or services, and/or particular names of business entities. If it is not a potential customer, but is a repeat customer, the host computer can store a specific PGA for this particular customer and, upon receipt of a call from this repeat customer, automatically download to the repeat customer's computer all (or select) coupons for the PGA. The term coupon is intended to mean any paper certificate used to obtain anything of interest to a potential consumer, such as a special pricing, a discount, money, additional product, premiums, rebates, or any other item or thing of value or interest. If the Internet is used to obtain a connection to the host computer 18, a home page may be created using hypertext mark-up language (HTML) to access both textual and graphic representations of the coupons and/or certificates. Once the potential consumer identifies the coupon or certificate on the host computer 18, the potential consumer downloads the information required to print the coupon or certificate 24. The coupon data storage 20, associated with the host computer 18, is secured to prevent unauthorized tampering with the available coupon data. In one aspect once a printed vendor coupon is presented at a cash register, information on the coupon (e.g. encrypted or bar-coded) is validated against the information in the host computer and, after redemption, the system can account for the coupon with the vendor.

The coupons printed from the downloaded information obtained from the host computer 18 may be bar coded with identifying information containing the address of the client computer 10 and the date of the downloading of the information from the host computer 18. The bar coding may be encrypted by a random algorithm. The address information, PGA definition, and/or date may also be printed on the coupon. Optionally, this may be done without any encryption to discourage attempts to reproduce the coupon without authority. Additionally, proprietary symbols may be used on the coupons as well as special fonts that are not widely available to further discourage unauthorized reproduction of the coupons.

FIG. 5 generally illustrates the different functions and their interrelationship for the coupon distribution system of FIG. 4. The client 26 using a computer accesses the host system 28 either via the worldwide web on the Internet or directly to a bulletin board system. The client 26, in one embodiment, provides information to the host system 28 by a registration process 30; or, as noted above, the host computer automatically recognizes the geographic location of the customer. Once registered, the client 26 may access search functions 32 having access to data storage 36 and user analysis 38 of the host system 28. The search functions 32 are also coupled to a viewer and request function 34. The viewer and request function 34 has access to the data storage 36 and the user analysis 38. The viewer and request 34 permits the client 26 to view or request selected coupons, to enlarge or reduce a PGA, and to input an alternate location for determining a new PGA. After the client 26 has searched for and made a request, the user analysis 38 having coupon information is coupled to numerical coding and bar code encryption 40, which in turn is connected to output 42 for eventual downloading to the client 26. The client 26 may then print out the coupon as illustrated in FIG. 4. The host system 28 may also be used to provide information for a survey 44. The survey 44 may provide information particular to the customer or client 26. The survey 44 may contain, inter alia, lists of customers for a particular PGA and/or for all PGA's of record. The host system 28 is, in one aspect, operated by a system operator 46 which is coupled to the data storage 36 and the user analysis 38. The functions of the host system 28 are preferably all located in a secured area. This prevents any unauthorized tampering with the host system 28.

As an alternative for the system of FIG. 4, the customer may have a card as previously described and instead of (or in addition to) actually printing out a coupon, the customer may use the card as described above to automatically take advantage of a coupon; or the discounts may be used in the other ways described above either online or when the consumer goes to a vendor location.

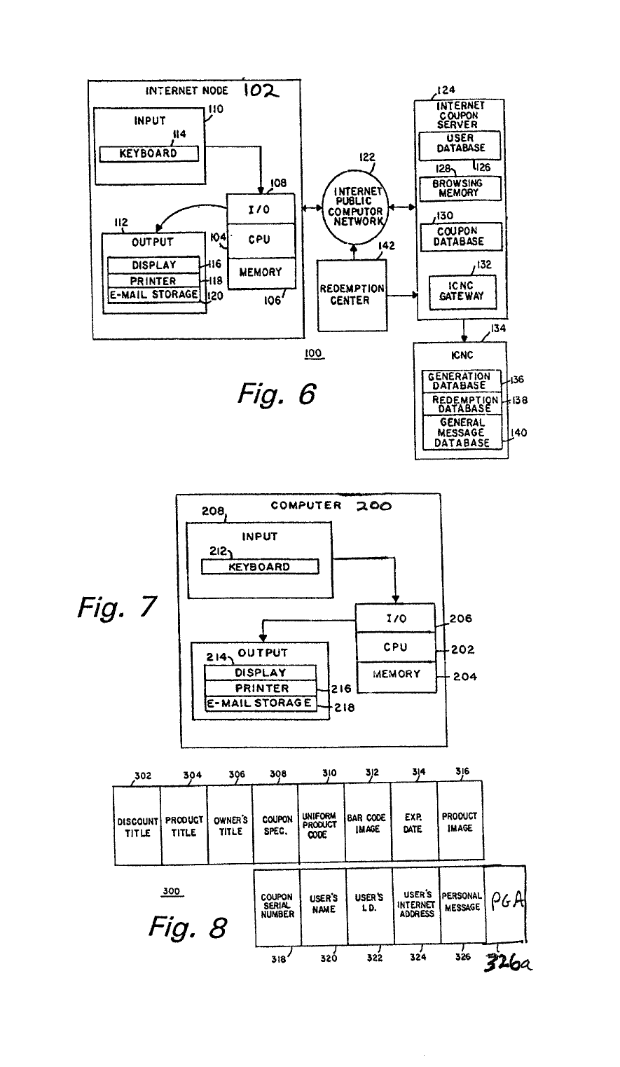

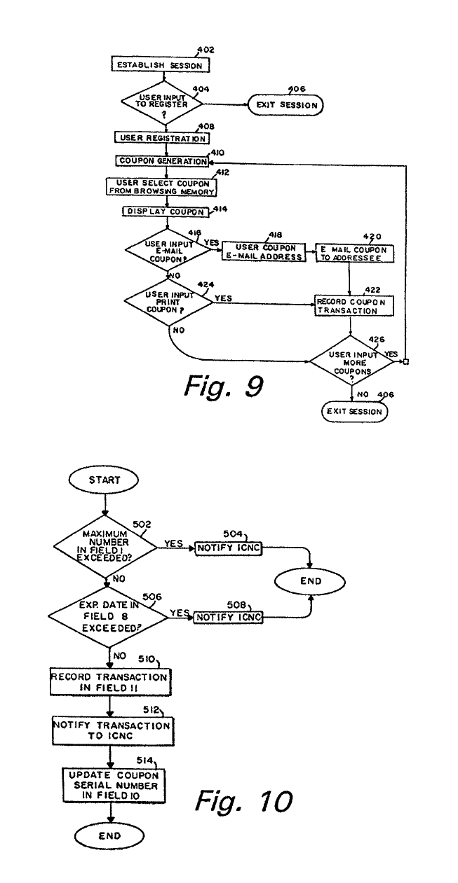

### FIGS. 6-14

The present invention, in certain aspects, discloses a method of generating a desired coupon in an electronic coupon communication system and/or generating a stored indication of said coupon and/or generating a message on, e.g., a magnetic strip card indicating said coupon. In these aspects the present invention is an improvement of the subject matter of U.S. Pat. No. 5,855,007 which is incorporated fully herein for all purposes. In certain aspects the method includes: identification of a computer user's pertinent geographic area (PGA) by a Coupon Server; during an on-line session between the user and the Coupon Server; selection of an electronic coupon (or one or more of the other coupon generating/indicating options listed above) by a user of a computer network node during an on-line session with a computer network Coupon Server; selecting a coupon for said PGA from said computer network Coupon Server; receiving a user selection of the electronic coupon during the on-line session from said computer network Coupon Server to said computer network node; transmitting the electronic coupon to the user's computer network node during the on-line session; and printing out on a printer of the user the coupon and/or coding a magnetic strip card of the user with electronic information about the electronic information about the electronic coupon and/or storing in a database the electronic information so that the user and/or coupon provider may access the database for the electronic information at the user's location, at a remote site, and/or at a place of sale. The computer network coupon server of this embodiment may be the host computer or part of the Host System or any embodiment disclosed herein.

In certain aspects a system useful in such methods includes: (a) a network node for selecting, receiving and printing electronic coupons over a public computer network such as the Internet, the node including an optional display coupled to a control processing unit for displaying at least one electronic coupon; a memory for storing electronic coupons received through electronic transmission from an Internet Coupon Server, which memory permits browsing on the display; and a user input device coupled to said central processing unit to permit a user to make an on-line selection of one of a plurality of electronic coupons collectively stored in said Internet Coupon Server's memory; (b) Internet Coupon Server coupled to an Internet Coupon Notification Center, the Internet Coupon Server having a memory for storing electronic coupons received from an Internet Coupon Server's supplier; a central processing unit for generating and transmitting electronic coupons, for recording and transmitting electronic coupon transactions, and an Internet Coupon Notification Center Gateway for enabling communication with said Internet Coupon Notification Center; (c) the Internet Coupon Notification Center having optional means for recording serial numbers of coupons generated by an Internet Coupon Server; and, optionally (d) an electronic coupon with a plurality of digital representations of product image and uniform product bar code; a plurality of digital representations of indicia identifying discount information, product title, coupon owner's title, redemption specification, uniform product code, expiration date, coupon serial number, user's name, user's identification number, user's Internet address and user's personalized message. Such a system may also have means for coding a user's magnetic strip card with information about the coupon which can be accessed at a point of sale or other remote location. Such a system may also include an electronic database with information about the electronic coupon accessible at the user's computer and at a point of sale.

In carrying out one form of this invention, there is provided an electronic coupon communication system and method therefor, the electronic coupon communication system comprising an Internet node, an Internet Coupon Server, and an Internet Coupon Notification Center communicating over a public computer network such as the Internet.

During an on-line connection between an Internet node and the Internet Coupon Server, the Internet coupon server determines a user's pertinent geographic area (PGA), provides coupons available in the PGA, accepts coupon selection from the PGA from a user, and then transmits the unique Internet coupon back to the user's printing device or user's electronic mail storage device, or accomplishes one of the other possible coupon retrievals and/or redemptions mentioned above. It further, optionally, records the transaction to the coupons' Internet Coupon Notification Center which at the time of actual purchase will verify coupon's validity, update user's billing information and record coupon's redemption.

The invention, in certain aspects, has an electronic coupon communication system with-a network node for selecting, receiving and printing electronic coupons over a public computer network such as the Internet, the node, optionally, including a display coupled to a control processing unit for displaying at least one electronic coupon, a memory for storing electronic coupons received through electronic transmission from an Internet Coupon Server, which memory permits browsing on the display, a user input device coupled to the central processing unit to permit a user to make an on-line selection of one of a plurality of electronic coupons for a PGA collectively stored in the Internet Coupon Server's memory, the Internet Coupon Server being coupled to the Internet Coupon Notification Center, the Internet Coupon Server having a memory for storing electronic coupons received from an Internet Coupon Server's supplier, a central processing unit for generating and transmitting electronic coupons and for recording and transmitting electronic coupon transactions, an optional Internet Coupon Notification Center Gateway for enabling communication with the Internet Coupon Notification Center, an Internet Coupon Notification Center, including means for recording serial numbers of coupons generated by an Internet Coupon Server, means for recording and updating transactions pertaining to redeemed electronic coupons, and an electronic coupon, with a plurality of digital representations of product image and uniform product bar code, a plurality of digital representations of indicia identifying discount information, product title, coupon owner's title, redemption specification, uniform product code, expiration date, coupon serial number, user's name, user's identification number, user's Internet address and user's personalized message.

The invention has, optionally, in certain aspects computer machine means for storing electronic coupon elements, including means for generating electronic coupons, means for storing a collection of electronic coupons, means for recording coupon transmission, means for transmitting information about coupon transactions to a user and/or to an accessible database, means for coding a magnetic strip card with information about the coupon, means for accessing the information at a remote site like a point of sale, and means for recording user data. The Internet Coupon Server, utilizes a method of operation including generating a new electronic coupon with a unique serial number upon the beginning of an on-line session with an Internet node, transmitting the selected electronic coupon over a public computer network, and recording the transmission in the accessible coupon database.

The invention in certain aspects, provides a method of generating a desired coupon in an electronic coupon communication system, the method including selecting an electronic coupon for a predetermined PGA by a user of a computer network node during an on-line session with a computer network Coupon Server, selecting a coupon from the computer network Coupon Server, generating a new coupon and/or providing other coupon retrieval and/or coupon redemption options as described above. Such a method may include one, some, or all of the following: receiving a user selection of the electronic coupon during the on-line session from the computer network Coupon Server to the computer network node, transmitting the electronic coupon to the user's computer network node during the on-line session, displaying the electronic coupon on a display device on the computer network, generating an optional request message for requesting the electronic coupon to be sent electronically, transmitting the optional request message corresponding to the selection of the electronic coupon request message including the electronic mail address of destination, arranging a coupon data base update in response to the electronic coupon transmission, for recording the transaction, including the user's identification number and coupon serial number, changing the coupon serial number in coupon database, sending a message to a computer network Coupon Notification Center, the message comprising the coupon serial number and the user's identification number. The electronic coupon generation process includes taking coupon indicia and digital representations of graphical images in the coupon database, coupling the coupon indicia with the user indicia in the user database, and placing the coupon indicia in a browsing memory to represent an electronic coupon. Coupon verification includes verifying the validity of an electronic coupon at a redemption center by accessing the computer network's Coupon Notification Center's coupon generation database. Coupon redemption notification occurs when the redemption center records the redemption of coupons by sending a message to the computer network Coupon Notification Center's redemption database.

The present invention in the embodiment shown in FIGS. 6-14 has a communication system 100 in which an Internet node 102 is defined as a general purpose digital computer or similar machine device connected to a public computer network, which will be identified as the Internet 122, over digital and analog wire lines, utilizing dial-up telephone lines or direct telephone lines through the public switched telephone network (PSTN) or integrated services digital network (ISDN). Specifically, Internet node 102 can communicate using Internet Protocol (IP) with another computer connected into a public computer network such as the Internet 122. Internet Protocol (IP) RFC 791, Transmission Control protocol (TCP) RFC 793, the TCP/IP protocol suite which is described in RFC 1122, and associated other RFCs mentioned below, are all available from SRI International, DDN Network Information Center, Room EJ291, 333 Ravenswood Avenue, Menlo Park, Calif. 94025. However other communication devices, such as personal communicators coupled to a public computer network through wireless transmissions are contemplated within the scope of the present invention for all embodiments disclosed herein.

FIG. 7 illustrates an exemplary Internet node (computer) 200 in accordance with the teachings of the present invention. Shown is a computer 200 which comprises three major components. The first of these is an input/output (I/O) circuit 206 which is used to communicate information in appropriately structured form to and from other portions of the computer 200. In addition, the computer 200 includes a central processing unit (CPU) 202 coupled to the I/O circuit 206 and a memory 204. These elements are those typically found in most general purpose computers and, in fact, computer 200 is intended to be representative of a broad category of data processing devices. A display monitor 2214 is shown coupled to the I/O circuit 206 and issued to display images generated by CPU 202 in accordance with the present invention. Any well known variety of cathode ray tube (CRT) or other type of display may be utilized as display 214. Furthermore, computer 200 preferably includes one or more input devices which are coupled to the I/O circuit 206 for receiving input from a user. For example, user input can be received by means of a keyboard 212. The computer 200 preferably includes one or more output devices coupled to the I/O circuit 206 for presenting information to the user of the computer. For example, a high resolution printer 216 can be coupled to the I/O circuit 206 for printing hard copy to communicate information to the user of the computer 200.

As shown in FIG. 6 the Internet node 102 is coupled to an Internet Coupon Server 124 via Internet 122. The Internet Coupon Server 124 is any general purpose digital computer which serves as an “Internet Host” as described in the Internet Protocol RFC 791, and contains electronic coupons 300 and would preferably include a user database 126 which would keep track of the individual users registered with the Internet Coupon Server, a browsing memory 128 where representative coupon or coupons are stored and ready for selection by users, and a coupon database 130 which will be more fully discussed below. In addition, the Internet Coupon Server 124, also includes Internet Coupon Notification Center Gateway 132 (ICNC gateway) for communicating with a plurality of Internet Coupon Notification Centers (UCBC) 134. The ICNC gateway 132 preferably also includes a computer database identifying interfacing information for accessing one or more ICNCs 134 through the interface. ICNC 134 could be either communicating with the ICNC gateway 132 over public computer network such as the Internet 122, as shown in FIG. 6, or physically present within the Internet Coupon Server. Each ICNC 134 is the owner of one particular category of coupons which gives $0.25 discount on “Ben & Jerry's Vanilla Bean Ice Cream”, and could comprise a coupon generation database 136 for storing data about electronic coupons generated by the Internet Coupon Server 124, a coupon redemption database 138 for storing data about electronic coupons redeemed by users, general message database 140 for storing messages of general nature, and optionally, a printing device which records coupon transactions. Periodically, the ICNC 134 can communicate with the Internet Coupon Server 124, such as by the Internet Coupon Notification Center Gateway 132, and update Internet Coupon Server's Coupon Database 130, regarding the discount value of the coupon, number of coupons available, and coupon specifications. In this way, the Internet Coupon Server can maintain current information on electronic coupons 300 available to consumers. Typically, these consumers would be users of computing devices that are connected into public computer networks such as the Internet 122. As new providers of coupons become members of the electronic coupon communication system 100, they can establish ICNCs 134 and make their electronic coupons available to consumers over the Internet Coupon Server 124.

As shown in FIG. 8, an electronic coupon 300 is preferably a combination of indicia and graphics which communicates discount information 302, product title 304, owner's title 306, owner's coupon specification 308, uniform product code 310, digital representations of graphic images of a bar code 312, expiration date 314, digital representations of graphical images of the product 316. in addition coupon also contains its unique serial number 318 and would preferably contain customer's name 320, customer's identification number 322, customer's Internet address 324, personalized message 326 tailored to a particular customer and user's PGA 326a. The discount information 302 bears indicia identifying a particular value of the coupon. The electronic coupon 300 also includes the product title 304 which bears indicia identifying the product to which the coupon applies, owner's title 306 which bears indicia identifying a particular person or company participating in the electronic coupon communication system 100, as well as the owner's coupon specification data 308 which bears indicia that communicate the coupon owner's instructions to the consumer and the coupon redemption center, regarding coupon redemption. Uniform product code 310 bears the standardized product code provided to the electronic coupon communication system 100 by the coupon's owner which serves his or her own accounting purposes. Similarly, digital representation of a graphical image of a bar code 312 is a standardized machine readable code provided to the electronic coupon communication system 100 by the coupon's owner which serves his or her own accounting purposes. Expiration date 314 bears indicia indicating the expiration date of the coupon (if any). Furthermore, digital representation of a graphical image of the product 316 could bear a symbol, logo or an image related to the product graphically identifying the product. In addition, digital representation of the bar code's 312 and the product's 316 graphical image could utilize any of the image compression algorithms commonly used by the general computing devices, such as the Joint Photographic Expert Group (JPEG) algorithm. Furthermore, electronic coupon 300 also contains a unique coupon serial number 318 generated by a coupon generation process 410 which identifies each particular electronic coupon 300 and plays an important role in marketing research and micro marketing techniques utilized by the coupon's owner. In the preferred embodiment of the invention, the electronic coupon 300 also contains customer's name date 320 bearing indicia pertaining to the name of coupons' user, customer's identification number (I.D.) 322 bearing customer I.D. assigned to the user by the Internet Coupon Server 124 during a registration process 408 having the customer's Internet address 324 and a personalized message 326 which bears a marketing message generated during the coupon generation process. Indicia pertaining to the coupon 302, 304, 306, 308, 310, 312, 314, 316 and 318, for sellers are stored in the coupon database 130 before the coupon generation process 410 occurs. Indicia pertaining to consumer's personal information 320, 322, 324 and 326 are stored in the user database 126 before beginning the coupon generation process 410. After the coupon generation process 410, all indicia are stored, combined in the browsing memory 128 to represent an electronic coupon 300.

An electronic coupon 300 communicates a message to the user of the Internet node 102 when, for example displayed on a viewing display 116 during the on-line session or stored in memory in the form of electronic mail 120, or when printed as a hard copy on user's printer 118.

A person can select an electronic coupon 300 from the Internet Coupon Server 124, print out a hard copy and redeem it at the coupon redemption center 142 (retain outlet) or the user could send the coupon using electronic mail from the Internet Coupon Server 124 directly to the redemption center' general computing device connected into public computer network such as the Internet 122. The redemption center 142 would have an option to verify the legitimacy of the electronic coupon 300 by contacting coupon owner's ICNC 134 using various communication means.

According to certain aspects of the present invention, user's general computing device connected to the public network such as the Internet 122, establishes an on-line session with the Internet Coupon Server 124, preferably goes through the registration process 408 if the user is a new user, and then, after a PGA is determined for the user makes a selection 412 from the available coupons for that PGA in the Internet Coupon Server's browsing memory 128 which contains a selection of coupons organized in a database.

In one preferred embodiment of the invention, browsing is customized so that it suits the needs and shopping patterns of a particular user for a particular PGA. By entering user input, such as through the keyboard 114, the user can browse through the available coupons and make a selection of one coupon 300. For example, user input accepted through the keyboard 114 can step through or browse through the available electronic coupons for a particular PGA in the Internet Coupon Server's browsing memory 128 during an on-line session and by having the Internet Coupon Server 124 sequentially transmit digitized pattern of the electronic coupon over public computer network such as the Internet 122, to Internet node's 102 output device, such as the display 116. Once the user viewing the display 116 selects an electronic coupon 300 being displayed, such as by entering user input at the keyboard 114, the Internet Coupon Server 124 may ask the user to choose if the coupon is to be mailed electronically, Internet Coupon Server 124 prompts the user to input an electronic mail address 418. When electronic mail address is inputted, Internet Coupon Server 124 mails the coupon electronically to the addressee 420.

The user may choose to email the coupon to him or herself or to an accessible storage database allowing him or her to store the coupon for a later date handling or to send it directly to the vendor's Internet node over public computer network. In the preferred embodiment of the invention the coupon can be mailed in a simple ASCII format using Simple Mail Transport Protocol (SMTP) or as a graphical image using Multipurpose Internet Mail Extension (MIME). (SMTP RFC 821 and MIME RFCs 1521 and 1522 describe in detail the above mentioned electronic mail protocol and standard.) However, other electronic mail protocols and standards used for electronic mail communication in public computer networks are also contemplated within the scope of the present invention. If the user elects not to mail the coupon electronically, Internet Coupon Server 124 prompts the user to input 424 whether the coupon is to be printed on the user's printing device 118. If the user chooses the printing option, the Internet Coupon Server 124 sequentially transmits coupon's digital data pattern to the Internet node's CPU 104 and the Internet node's printing device 118. Once the user has chosen one of the available options, transaction is recorded in the coupon database 130. User is then prompted to input whether to continue with coupon browsing or to exit the session 426. If the user chooses to continue with coupon browsing, Internet Coupon Server 124 starts a new coupon generation process 410 and directs the user to the browsing memory 128 to select another coupon 300. If the user chooses to discontinue with coupon browsing, Internet Coupon Server 124 exits the session 406.

Upon coupon selection 412, the transaction is recorded in the coupon database 130, said database containing Coupon Structure (Table 1). Field 1 “Number of coupons available” bears indicia providing information on the maximum number of electronic coupons the current unique coupon serial number 318 which makes a particular coupon unique. Fields 2, 3, 4, 5, 6, 7, 8 and 9 of the database have already been described in the explanation of FIG. 8. Field 11 will be explained in detail below.

TABLE 1
Coupon Structure

| | |
|---|---|
| 1. | Number of coupons available |
| 2. | Coupon discount information |
| 3. | Product title |
| 4. | Owner's title |
| 5. | Owner's coupon specification data |
| 6. | Uniform Product Code |
| 7. | Graphical presentation of a Bar Code |
| 8. | Expiration date |
| 9. | Graphical presentation of a product |
| 10. | Coupon Serial Number |
| 11. | Past transactions |

As shown in FIG. 10, the Internet Coupon Server 124, accesses the coupon data base and verifies whether the maximum number of coupons is exceeded 502. If it is exceeded, the Internet Coupon Server 124 notifies this information 504 over Internet Coupon ICNC gateway 132 to the coupon owner's ICNC 134. If the maximum number of coupons was not exceeded, Internet Coupon Server 124 verifies whether the coupon expiration date was not exceeded, Internet Coupon Server 124 notifies this information 508 over the Internet Coupon ICNC gateway 132 to the coupon owner's ICNC 134. If the expiration date was not exceeded, the Internet Coupon Server records the transaction 510 in the field 11 which contains past transactions, by first storing customer's name, then customer's identification number and then the current coupon serial number. After the transaction is recorded, the Internet Coupon Server 124 notifies the transaction 512 over the Internet Coupon ICNC gateway to the coupon owner's ICNC 134 by first sending customer's name 320, then customer's identification number 322 and then the current coupon serial number 318. After the transaction is recorded, the Internet Coupon Server 124 notifies the transaction 512 over the Internet Coupon ICNC gateway to the coupon owner's ICNC 134 by first sending customer's name 320, then customer's identification number 322 and then the current coupon serial number 318., After the ICNC 134 has been notified, the Internet Coupon Server 124 updates 514 the coupon serial number 318 which serves as a coupon's unique indicia. This action 514 comprises of either adding or subtracting one number to the already existing coupon serial number, or changing the coupon serial number to random or partly random indicia. Any combination or indicia and any formula for the formation of coupon serial number is contemplated within the scope of the present invention.

FIG. 11 illustrates the user registration process. User database contains User Data Structure as shown below in Table 2.

TABLE 2
User Data Structure

| | |
|---|---|
| 1. | User name |
| 2. | User login name |
| 3. | User password |
| 4. | User identification number |
| 5. | User demographic information |
| 6. | User customized message |

Field 1 bears indicia identifying user's first and last name. Field 2 bears indicia identifying user's system login name. Field 3 bears indicia identifying user's secret code i.e. password. Field 1, 2 and 3 are indicia which the Internet Coupon Server receives from the user during the initial registration process and places in the user database. Field 4 bears indicia identifying user's identification number assigned to the user by the Internet Coupon Server during the time of initial registration. Field 5 bears indicia identifying user's demographic information which the Internet Coupon Server receives from the user during the initial registration process. Field 6 bears indicia identifying personalized message to the user, which can be periodically changed.

According to one preferred embodiment of the invention, in order for the user to enter the Internet coupon communication system, Internet Coupon Server 124 requests login name and password from the user 602. Internet Coupon Server 124 then verifies 604 whether user's login name (login) and password match any login and password in the user database 126. If login and password match any login and password in user database, the registration process ends. If the login and password do not match any login and password in the user database, the user is prompted to input his name 606 which is then stored in field 1 of the user database. The user is then prompted to input preferred login name and password 606 for later use, which are then stored in fields 2 and 3 respectively. The user is the prompted to input demographic information 608, such a location, sex, occupation, household income and any other pertinent demographic information preset by the Internet Coupon Server 124, which is then stored in the field 5 of the user database 126. The Internet Coupon Server 124 then determines a PGA for the user and assigns an identification number to the user 610 and stores it in field 4 of the user database. Subsequently, Internet Coupon Server assigns the standard customized message 612 in field 6 of the user database which could be changed from time to time.

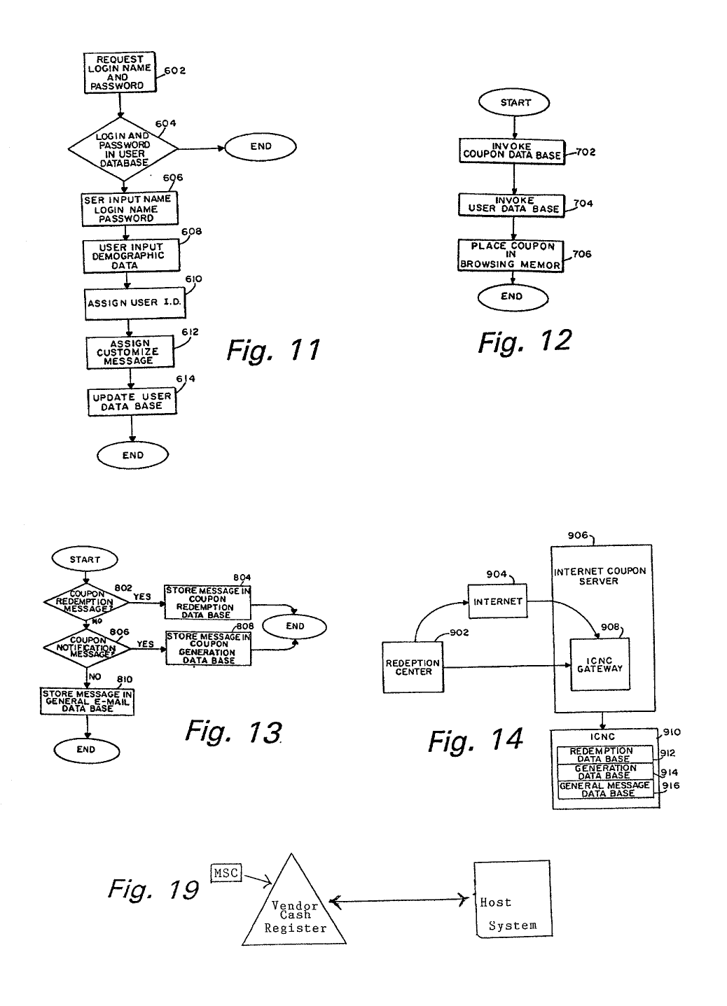

FIG. 12 illustrates a preferred embodiment of the coupon generation process 410 wherein the Internet Coupon Server 124 first invokes 702 coupon database 130 and takes the information contained in the coupon database fields 2, 3, 4, 5, 6, 7, 8, 9, and 10 as illustrated in Table 1. Internet Coupon Server 124 then invokes the user database 126 and takes the name of the current user, current user's identification number, user's Internet address, PGA, and user's personalized message (if any) used for micro marketing techniques. All coupon elements for the PGA are then placed in combination, in the Internet Coupon Server's browsing memory 128, ready for user's perusal. In the preferred embodiment of the present invention, the Internet node 102 will access Internet Coupon Server's browsing memory 128 during the on-line session over public computer network such as the Internet 122 using Internet Protocol (IP). In the event that the Internet Coupon Server 124 does not contain the user database 126, it is contemplated in the scope of the present invention that a combination of coupon elements described in FIG. 8 could be placed directly in the browsing memory 128, without the added features of elements 320, 322, 324, 326 or without the added feature of an element representing coupon serial number 318 in the event that Internet Coupon Server 124 does not contain the coupon database 130. The user may, optionally, have the PGA re-determined by the Internet Coupon Server by enlarging or reducing the PGA extent.

FIG. 13 illustrates an operational sequence for the Internet Coupon Notification Center (ICNC) 134 according to the preferred embodiment of the present invention. It is envisioned in the preferred embodiment of the present invention that each coupon category has its own ICNC 134. Several ICNCs can be coupled together and contained in one general computing device connected to the Internet Coupon Server 124 over the public computer network, or could be contained in the Internet Coupon Server 124 itself. Each ICNC is comprised of the coupon redemption database 138, the coupon generation database 136 and the general message database 140. The coupon redemption database 138 stores electronic messages identifying redeemed coupons, coupon generation database 136 identifying coupons generated by the Internet Coupon Server 124 but not yet redeemed, and a general message database 140 containing messages of general nature. When an ICNC 134 receives an electronic message from the Internet Coupon's ICNC Gateway 132, it first verifies whether that electronic message is a coupon redemption message 802 notifying the ICNC 134 that a particular coupon in the ICNC's coupon category was redeemed. If the message is a coupon redemption message, the message is stored 804 in the ICNC's coupon redemption database 138, said message containing coupon serial number and redemption center's identification number. If the message is not a coupon redemption message, the ICNC verifies whether the electronic message is a coupon generation message 806, thereupon notifying the ICNC 134 that a particular coupon in the ICNC's coupon category was generated by the Internet Coupon Server 124. If the message is a coupon generation message, the message is stored 808 in the coupon generation database 136, the message containing coupon's serial number and the user's identification number. Otherwise, the message is stored 810 in the general message database 140. Thus, the information related to a particular coupon may be redeemed anywhere, including at a point of sale.

FIG. 14 illustrates an electronic coupon verification and redemption system according to a preferred embodiment of the present invention. The redemption center (retail outlet) 902 can verify electronically the validity of the coupon, by accessing by various electronic means, the ICNC's coupon generation database 914 and coupon redemption database 912, and verifying that the coupon exists in the database and/or whether a coupon brought by a redemption center's customer is indeed valid. Similarly the redemption center 902 can also notify the redemption of the coupon to the coupon's ICNC 910 using various electronic means. In a preferred embodiment of the present invention, the redemption center's computing device is coupled with Internet Coupon Server's ICNC gateway 908 through communication network, such as electronic data interchange network, public computer network or wireless network. After the redemption center 902 establishes a connection with the ICNC gateway 908, the redemption center reports coupon serial number to the ICNC gateway 908. Based on the coupon serial number, the ICNC gateway 908 identifies the coupon category and the coupon's ICNC 910 and establishes a connection with the ICNC 910, through a computer interface, telephone dial-up interface or an electronic data interchange interface, thus enabling communication between the redemption center's computing device and ICNC 910.

Optionally the ICNC may contain a billing system which credits the account of the current coupon holder, such as the redemption center or a coupon user, and debits the account of the coupon owner. Further more, the ICNC may contain a demographic research system which would access Internet Coupon Server's registration database and coupon database and research demographic information. Additionally, the ICNC may contain a control system which would enable it to access Internet Coupon Server's coupon database and change the coupon information electronically.

### A Card System

In certain embodiments the present invention provides systems and methods that are an improvement of the subject matter of U.S. Pat. No. 5,806,044 which is incorporated fully herein for all purposes. In one aspect such a system includes a portable card as described in U.S. Pat. No. 5,806,044 or a plurality of such portable cards, and a routing system for receiving a signal and generating network addresses in response to an inter-network address in the received signal, the routing system including a plurality of wide area communication links, and a coupon system with a first computer; and a second computer, wherein the first computer includes circuitry for sending a first signal to the routing system, the first signal including a signal corresponding to a PGA and to a product, and an inter-network address corresponding to the second computer, to cause the routing system to generate a plurality of network addresses, each of the plurality of network addresses corresponding to a respective computer in a respective computer network, and wherein the second computer includes circuitry for receiving the first signal, and wherein the system further includes: a first processor, responsive to the first signal received by the second computer, for sending a card signal to a portable card in the plurality of cards, the card signal corresponding to the PGA and to the product; and a second processor, spatially removed from the first processor, for receiving the card signal from the portable card, the computer network of this embodiment may be used in any embodiment disclosed herein.

In another aspect such a system includes such a portable card or a plurality of such portable cards, and a routing system for receiving a signal and generating a routing signal in response to an inter-network address in the received signal, the routing system including a plurality of wide area communication links, a coupon system with a first computer; and a second computer, wherein the first computer includes circuitry for sending a first signal to the routing system, the first signal including a signal corresponding to a PGA and to a product, and an inter-network address corresponding to the second computer, to cause the routing system to generate a plurality of routing signals, each of the plurality of routing signals corresponding to a respective portion of a signal path between the first and second computers, and wherein the second computer includes circuitry for receiving the first signal, and wherein the system further includes: a first processor, responsive to the first signal received by the second computer, for sending a card signal to a portable card in the plurality of cards, the card signal corresponding to the PGA and to the product; and a second processor, spatially removed from the first processor, for receiving the card signal from the portable card.

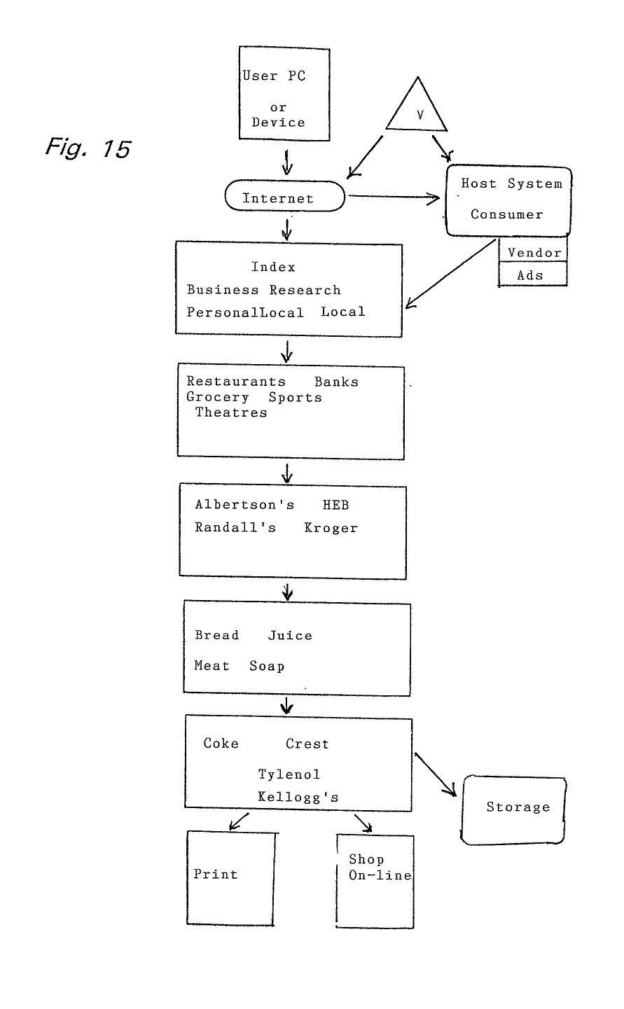

### FIGS. 15-19

FIG. 15 illustrates another method and system according to the present invention. A potential customer (“user”) uses a personal computer or other appropriate electronic device (e.g. phone, laptop computer, personal communicator, SMARTCARD™—any of which may be used instead of a personal computer in any embodiment of the invention) to communicate with a communication system, e.g. the Internet. Via the Internet, the user is put in communication with an Internet Service Provider's (ISP) Home Page. From this Home Page, the user (e.g. by pushing the Enter key or clicking a mouse on a particular screen area or icon) is put in communication with a Host System's Index screen (and/or an ISP's Index screen or screens) which contains a variety of possible selections, e.g., but not limited to, Business, Research, Personal (e.g. personal finance, etc), and Local. The user selects a category, e.g. “Local” and is thereby put in communication with a Host System computer or computers (“Host System”) for providing service, information, online connection to vendors, online shopping, discounts, coupons and/or coupon information and/or vendor information, advertising and/or other services. In one aspect, by selecting “Local” the consumer user of the system, without any further action, has automatically activated means within the Host System for receiving information about the user's location (either based on the phone number from which the user is calling and/or based on information previously supplied by the user and correlated in memory with this particular phone number), for determining a specific PGA for this user, and for then supplying further information related to this PGA. The system can also inform the user that this has occurred and query whether the user wants to proceed in this way, to change the PGA, and/or ignore PGA's and have the system proceed without any PGA limits. Alternatively, the system can perform a search without PGA limits for a particular item, e.g. watches. At this point, in one aspect of the present invention, based on a pertinent geographic area (PGA) determined by the Host System, certain information is automatically downloaded to the user's computer or device, e.g., but not limited to, information on various types of businesses in the PGA, e.g., but not limited to Restaurants, Banks, Groceries, Sports, and Theaters. The user chooses a business category, e.g. Grocery, and the Host System then present specific grocery businesses to the user, e.g. Albertson's, Kroger, HEB, and Randall's. The user clicks a mouse (or uses keyboard keys) to select a particular grocery store and is then presented with a listing of the various categories of goods provided by the store, e.g. bread, juice, milk, meat, soap. Following the user's review of and selection of goods, the user is automatically presented with current sales offers and/or coupons available for specific items in the store, e.g. Coke™ beverage, Tylenol™ analgesic, Kellog's™ cereal, and Crest™ toothpaste. The user then has the coupon and discount redemption options described above for receiving the benefit of the discounts, etc. at a vendor location and/or for printing out a coupon on a personal computer printer (“Print”) for physical redemption at a retail site; storing (“Storage”) the coupon information (either in a Host system database and/or in a vendor apparatus such as, but not limited to, a cash register with appropriate memory means or a vendor computer in communication with the Host System) for future use, either to print out a coupon or for retrieval and/or use at a remote site or point of sale; or to then engage in on-line shopping (“On Line Shop”) with a particular vendor. This on-line shopping may be accomplished via a hyperlink from the Host System to a particular vendor.

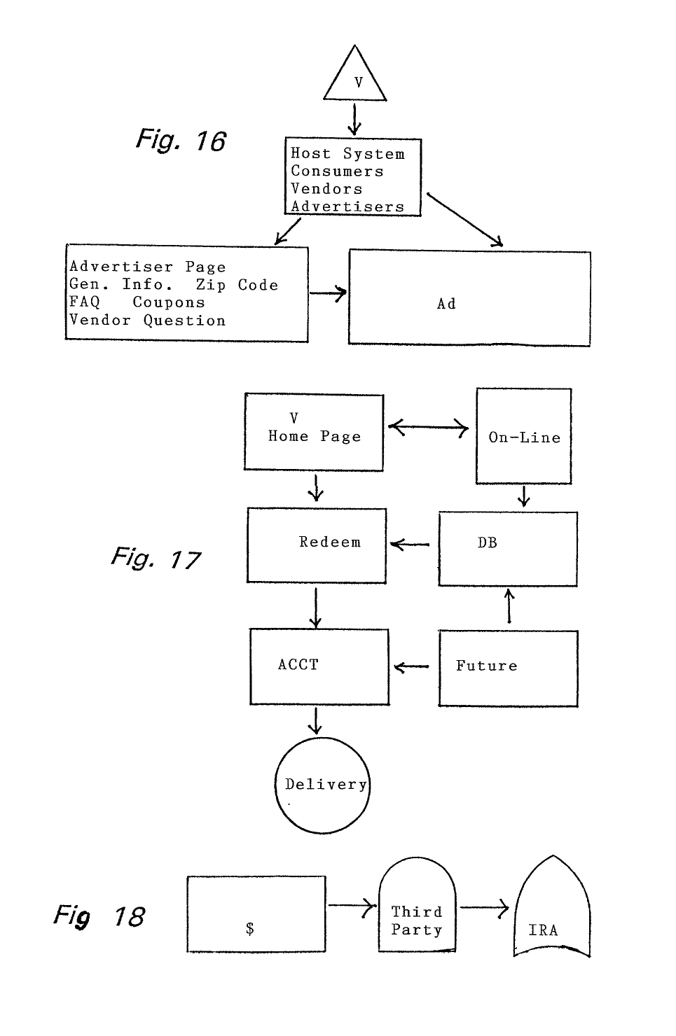

Optionally, a vendor, with a personal computer or other appropriate communication device either contacts the Host System directly (e.g. via phone, mail, email) or, via the Internet, contacts the Host System to place advertising information in the Host System (See FIGS. 15 and 16). At the Host System Web Page “Host System”), the vendor chooses “Advertisers” and is presented with a Host System Advertising Page that presents a variety of categories and a vendor questionnaire (“Vendor Question”). The vendor chooses the questionnaire; inputs the requested information that may include some or all of the following: type of business, credit references, zipcodes and/or phone area codes for vendor locations, or other geographic location designators for the locations; payment and accounting arrangements, including but not limited to credit card account numbers and banking identifiers (which, in one aspect, the Host System is authorized to access directly). The vendor can also produce and store an ad (“Ad”) for inclusion in the Host System database for review by consumers.

FIG. 17 illustrates a user's use of the system to directly contact a Vendor Home Page (“V Home Page”) to shop on-line (“On Line”) and/or to redeem a coupon (“Redeem”). In shopping on line a user reviews a vendor database (“DB”) (maintained by the vendor as part of the vendor's home page and/or available via the Host System via appropriate hyperlinks, etc.). Any applicable coupons related to a user selection are automatically applied and redeemed. Following this step, payment, charging, and/or billing arrangements are made (“ACCT”) and then the item(s) are processed for delivery to the user (“Delivery”). Optionally, discounts and/or coupons for future purchases (“Future”) are provided to the user. Future discount amounts maintained in computer records by the Host System and/or a Third Party Administrator (“TPA”), may be displayed and/or printed out for a consumer who has made a purchase that qualified for the future discount. The consumer's account information in the computer's databases maintains the future discount information for use with the next purchase at the same vendor. In one aspect the discount amount is held as a fiduciary responsibility on behalf of the vendor by a TPA appointed by a Host System. In one aspect, e.g., if a consumer makes a purchase and qualified for a future discount, a TPA forwards only a portion of the purchase price to the vendor and retains the remainder as a service fee. The Host System may charge a vendor a set fee, e.g. a certain dollar amount each month or quarter, and/or a fee for each transaction. If desired, when the future discount is applied to a future purchase, a new discount amount is calculated and handled as described above.

Alternatively, instead of (or in addition to) discounts and/or coupons for future purchase, the Host System as shown in FIG. 18 calculates and provides a dollar amount (“$”) to a third party (“3rd party”) based on the amount of purchases by the user, e.g. a financial institution, for a retirement account (“IRA”) for the user. Any type of retirement account may be used. This feature of discounts and/or coupons applicable in the “Future” can be incorporated into any system and/or method disclosed herein. any system and/or method according to the present may include the feature of making retirement account contributions as described above. In one aspect a consumer enters a pin number or other identification number into the system to access information related to discounts provided and to retirement account payments and balances. The host system can automatically pay a predetermined percentage of discounts received or of total purchases to the consumer's retirement account. This can be done at the expense of either the host system, of the vendor, and/or of the consumer. A third party can administer the retirement accounts. In one aspect retirement account payments are made automatically and in one particular aspect if a consumer fails to visit a vendor within a pre-set period (e.g. three to six months) an already accumulated amount is paid into the consumer's retirement account. Contribution amounts may be based on a percentage of a sale, a percentage of multiple sales, on the fact of one sale, on the fact of multiple sales (regardless of dollar amount, and/or on a level of total dollar amount of sales.

In one magnetic-card-based system according to the present invention, shown schematically in FIG. 19, a magnetic strip card (“MSC”) is used by a user. The MSC can be any existing credit card or retailer's card or it can be a specially issued card specific to this system. The MSC can be directly marketed to consumers as credit cards are now; or it can be provided by an Internet Service Provider as part of the Internet access service.

A user of a system as described above may have a magnetic strip card encoder device for encoding an MSC with discount and/or coupon information gleaned from the Host System (e.g. as in FIG. 15). The MSC can then be taken to a vendor's location and scanned to provide the information for an actual sale. Alternatively, the information may be stored in the Host System database and/or in a vendor computer and/or database without the necessity of encoding the MSC. The MSC can contain only information specifically identifying the user. By scanning the MSC at a vendor's location, the Host System or other appropriate system or computer(s) can validate the user's participation in the system and can correlate the user with the available discount and/or coupon and either store the information for later user, print a coupon or apply the appropriate discount to a sale. The user may also use the MSC at any suitable location with suitable apparatus to determine available discounts coupons for goods/services to be purchased. Alternatively vendor cash registers equipped with or connected to card swiping/reading apparatus can themselves store all available coupon information with or without a connection to the Host System. In one aspect, a cash register with appropriate electronic means and apparatuses (or connected to such) automatically calculates a percent discount on some or all items purchased following swiping/reading of an MSC (with or without validation).

As shown in FIG. 19, a consumer presents an MSC to a vendor's cash register and card swiping apparatus (“Vendor Cash Register”). The cash register automatically contacts the Host System for card validation. Following card validation, the vendor sends a listing of items to be purchased by the consumer to the Host System which, in turn, sends the vendor's cash register information regarding any applicable discounts, rebates, and coupons; or, alternatively, all current discounts, rebates, coupons, and/or sales prices for that vendor location are printed out and/or displayed. Optionally, the cash register prints out and/or displays individual discounts, rebates, and coupons and/or a total discount amount. The cash register or the Host System also, optionally, computes an amount of a future discount for this consumer (and/or a discount transferrable to another person) usable with this vendor at this vendor location and/or at any location of this vendor based on the amount of a current transaction and optionally, displays or prints this out for the consumer, along with the gross amount of the transaction. The vendor's system sends this information to the Host System which stores the amount of the future discount (as may the vendor's system itself). On a subsequent visit (the next visit and/or any other subsequent visit) of this consumer to the same vendor, the system applies the future discount to the next purchase and, optionally displays this and a net amount due or to be charged to the MSC or to a credit card after the discount has been applied. Based on the net amount due, another future discount is calculated and stored. This process can be done over and over again for all or some set number of transactions. At the Host System's discretion, if the full amount of a discount is not used on a subsequent visit, it may be applied to transactions in a later visit. Optionally the Host System can credit all or some part of an unused discount to the consumer's retirement account and/or can refund some or all of the discount amount directly to the consumer. In one aspect, this is done if the consumer fails to return to the specific vendor or fails to return in a set time period. Any future discount may have a set expiration date.

The present invention therefore, in certain embodiments, provides a method for generating vendor information including contacting a host system by a consumer, identifying a pertinent geographic area of interest to the consumer, identifying at least one vendor doing business in the pertinent geographic area, retrieving from the host system information related to the at least one vendor, and displaying said information for the consumer; and in one aspect such a method includes automatically displaying and/or downloading to a computer the information to the consumer.

The present invention therefore, in certain embodiments, provides a method for a vendor to provide a future discount to a customer of the vendor, the method including noting a transaction amount indicative of value of a transaction between the customer and the vendor, based on the transaction amount, calculating a discount amount to be applied to a future transaction between the customer and the vendor, storing the discount amount for future use, and informing the customer of the discount amount; and such a method including applying the discount amount to a future transaction of the customer.

The present invention therefore, in certain embodiments, provides a method for making a contribution to a retirement account of a customer of a vendor, the method including noting a transaction amount indicative of value of a transaction between the customer and the vendor, based on the transaction amount, calculating a contribution amount to be made to a retirement account of the customer, and making a contribution to the customer's retirement account in the amount of the contribution amount; and such a method wherein the vendor, the customer, a third party administrator and/or a host system make the contribution to the retirement account.

The present invention therefore, in certain embodiments, provides a method for generating a coupon including contacting a host system by a consumer, identifying a pertinent geographic area of interest to the consumer, identifying at least one vendor doing business in the pertinent geographic area, retrieving from the host system information related to the at least one vendor and at least one coupon currently provided by the at least one vendor, and generating a coupon corresponding to the at least one coupon.

The present invention discloses, in at least some if not all embodiments, a business system with a magnetic strip card with consumer identifying information encoded thereon said information identifying a consumer desiring to conduct a transaction with a vendor, a host system that maintains information about discounts from said vendor, an apparatus for reading information on the magnetic strip card, said apparatus interconnected with and in communication with the host system, and means for applying any applicable discount (coupon, rebate, sales price, volume discount, reward, etc.) related to said transaction for the benefit of said consumer. Such a system may have one, some, or all of the following in any combination: wherein the apparatus for reading the information is located at a location of the vendor; wherein the apparatus for reading the information is located at a location of the consumer; a computer at the location of the consumer for the consumer to communicate with the host system; means for automatically downloading information to the computer without a request from the consumer; means at the host system for receiving from the vendor transaction information about said transaction, and means at the host system for storing said transaction information; means for calculating a future discount for the consumer based on the transaction information; means for providing the consumer with information about the future discount; means for calculating an amount of a retirement account contribution for a consumer based on the transaction information; means for making a contribution to a retirement account of the consumer based on the calculated amount (e.g. but not limited to a contribution made by a third party administrator, by the vendor, by the host system, or by the consumer); means for providing the consumer with a physical coupon for use in a transaction with the vendor; means for determining a pertinent geographic area for the consumer (e.g. but not limited to, based on phone number, zip code, and/or information inputted by a consumer); means for displaying for the consumer information about the vendor for the determined pertinent geographic area (which may be reduced or enlarged in scope by the consumer); means for displaying for the consumer information about a desired product or service available in the pertinent geographic area; means for automatically determining the pertinent geographic area based on information about a consumer, e.g. but not limited to a phone number used by the consumer to contact the host system; wherein the information about the consumer includes a phone number used by the consumer to contact the host system and/or a zip code of the consumer' location; wherein the consumer uses the Internet global communications system or some other similar communications network to contact the host system; and/or means for automatically downloading to the computer information about a vendor without a request from the consumer.

The present invention discloses, in at least some if not all embodiments, a magnetic strip card with consumer identifying information encoded thereon said information identifying a consumer desiring to conduct a transaction with a vendor, a host system that maintains information about discounts from said vendor, an apparatus for reading information on the magnetic strip card, said apparatus interconnected with and in communication with the host system, means for applying any applicable discount related to said transaction for the benefit of said consumer, a computer at the location of the consumer for the consumer to communicate with the host system, means for automatically downloading information to the computer without a request from the consumer, means at the host system for receiving from the vendor transaction information about said transaction, means at the host system for storing said transaction information, means for calculating an amount of a retirement account contribution for a consumer based on the transaction information, means for determining a pertinent geographic area for the consumer, and means for automatically determining the pertinent geographic area based on information about a consumer to contact the host system.

The present invention, therefore, provides business systems that include, in at least certain embodiments, a magnetic strip card with consumer identifying information encoded thereon said information identifying a consumer, said consumer desiring to conduct a transaction with a vendor at a vendor location, a host system remote from the vendor location that maintains information about discounts from said vendor, an apparatus at the vendor location for reading the consumer identifying information on the magnetic strip card, said apparatus interconnectible with and able to communicate with the host system for ascertaining any discount of said discounts applicable to said transaction, and apparatus and/or systems apart from the magnetic strip card for automatically applying any applicable discount of said discounts related to said transaction at the vendor location for the benefit of said consumer, without consumer selection of any said applicable discount and without requiring consumer awareness of any said applicable discount. Such a business system may have one or some (in any possible combination) of the following: apparatus and/or systems at the host system for receiving from the vendor transaction information about said transaction, and apparatus and/or systems at the host system for storing said transaction information; apparatus and/or systems for calculating a future discount for the consumer based on the transaction information; apparatus and/or systems for providing the consumer with information about the future discount; apparatus and/or systems for calculating an amount of a retirement account contribution for a consumer based on the transaction information; apparatus and/or systems for making a contribution to a retirement account of the consumer based on the calculated amount; wherein said apparatus for reading the consumer identifying information on the magnetic strip card can communicate with the host system via the Internet global communications system; and/or apparatus and/or systems for automatically downloading to the computer information about said discounts without a request from the consumer.

The present invention, therefore, provides business systems that include, in at least certain embodiments, a business system including a magnetic strip card with consumer identifying information encoded thereon said information identifying a consumer, said consumer desiring to conduct a transaction with a vendor at a vendor location, a host system remote from the vendor location that maintains information about discounts from said vendor, an apparatus at the vendor location for reading the consumer identifying information on the magnetic strip card, said apparatus interconnectible with and able to communicate with the host system for ascertaining any discount of said discounts applicable to said transaction, apparatus and/or systems apart from the magnetic strip card for automatically applying any applicable discount of said discounts related to said transaction at the vendor location for the benefit of said consumer, without consumer selection of any said applicable discount and without requiring consumer awareness of any said applicable discount, a computer at the location of the vendor for communicating with the host system, apparatus and/or systems for automatically downloading information about said discounts to the computer without a request from the consumer, apparatus and/or systems at the host system for receiving from the vendor transaction information about said transaction, apparatus and/or systems at the host system for storing said transaction information, apparatus and/or systems for calculating an amount of a retirement account contribution for a consumer based on the transaction information, apparatus and/or systems for determining a pertinent geographic area for the consumer, and apparatus and/or systems for automatically determining the pertinent geographic area based on information about a consumer to contact the host system.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims.

What is claimed is:

1. A business system comprising
a magnetic strip card with consumer identifying information encoded thereon said information identifying a consumer, said consumer desiring to conduct a transaction with a vendor at a vendor location,
a host system remote from the vendor location that maintains information about discounts from said vendor,
an apparatus at the vendor location for reading the consumer identifying information on the magnetic strip card, said apparatus interconnectible with and able to communicate with the host system for ascertaining any discount of said discounts applicable to said transaction, and
means apart from the magnetic strip card for automatically applying any applicable discount of said discounts related to said transaction at the vendor location for the benefit of said consumer, without consumer selection of any said applicable discount and without requiring consumer awareness of any said applicable discount.

2. The system of claim 1 further comprising
means at the host system for receiving from the vendor transaction information about said transaction, and
means at the host system for storing said transaction information.

3. The system of claim 2 further comprising
means for calculating a future discount for the consumer based on the transaction information.

4. The system of claim 3 further comprising
means for providing the consumer with information about the future discount.

5. The system of claim 3 further comprising
means for calculating an amount of a retirement account contribution for a consumer based on the transaction information.

6. The system of claim 5 further comprising
means for making a contribution to a retirement account of the consumer based on the calculated amount.

7. The system of claim 1 wherein said apparatus for reading the consumer identifying information on the magnetic strip card can communicate with the host system via the Internet global communications system.

8. The system of claim 1 further comprising
means for automatically downloading to the computer information about said discounts without a request from the consumer.

9. A business system comprising
a magnetic strip card with consumer identifying information encoded thereon said information identifying a consumer, said consumer desiring to conduct a transaction with a vendor at a vendor location,
a host system remote from the vendor location that maintains information about discounts from said vendor,
an apparatus at the vendor location for reading the consumer identifying information on the magnetic strip card, said apparatus interconnectible with and able to communicate with the host system for ascertaining any discount of said discounts applicable to said transaction,
means apart from the magnetic strip card for automatically applying any applicable discount of said discounts related to said transaction at the vendor location for the benefit of said consumer, without consumer selection of any said applicable discount and without requiring consumer awareness of any said applicable discount,
a computer at the location of the vendor for communicating with the host system,
means for automatically downloading information about said discounts to the computer without a request from the consumer,
means at the host system for receiving from the vendor transaction information about said transaction,
means at the host system for storing said transaction information,
means for calculating an amount of a retirement account contribution for a consumer based on the transaction information,
means for determining a pertinent geographic area for the consumer, and
means for automatically determining the pertinent geographic area based on information about a consumer to contact the host system.

10. A business system comprising
a magnetic strip card with consumer-identifying information encoded thereon;
a host system that maintains information about discounts from vendors;
an apparatus for reading information on the magnetic strip card, the apparatus in communication with the host system and a payment processing system, the apparatus capable of initiating a real-time communication link with the host system and initiating a communication link to the payment processing system; and
wherein the host system maintains information about discounts from vendors and applies such discount on an itemized basis for the benefit of a consumer when the consumer purchases a discounted item at a vendor using the magnetic strip card.

11. A method for carrying out a purchase comprising the steps of:
reading at a point-of-sale terminal located at a vendor consumer-identifying information encoded on a device having a readable data string;
maintaining a database of discounts available at the vendor;
determining on a real-tiem basis whether the items purchased by the consumer are items offered at a discount by the vendor; and
transmitting a signal to the vendor to cause a discount to such items purchased by the consumer on an itemized basis that are identified in the database as being offered by the vendor at a discount.
